(19) United States
(12) Patent Application Publication
(10) Pub. No.: US 2007/0024189 A1
(43) Pub. Date: Feb. 1, 2007

(54) El element and method of producing the same

(75) Inventors: Yasuo Yamamoto, Kariya-city (JP); Takashi Inoue, Kuwana-city (JP); Masayuki Katayama, Handa-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/493,843

(22) Filed: Jul. 27, 2006

(30) Foreign Application Priority Data
Aug. 1, 2005 (JP) 2005-223090

(51) Int. Cl. H01J 1/62

(52) U.S. Cl. 313/506; 313/503

(57) ABSTRACT

An EL element includes a first electrode, a first insulating layer, a luminous layer, a second insulating layer, and a second electrode, which are laminated on an insulating substrate in this order. At least one of the first insulating layer and the second insulating layer is an HfO₂/TiO₂ film in which a plurality of HfO₂ films and a plurality of TiO₂ films are layered alternately.

### CROSS REFERENCE TO RELATED APPLICATION

This application is based on Japanese Patent Application No. 2005-223090 filed on Aug. 1, 2005, the disclosure of which is incorporated herein by reference in its entirety.

### BACKGROUND OF THE INVENTION

1. Field of the Invention

The present invention relates to an electro luminescence (EL) element, in which a luminous layer is sandwiched by electrodes through insulating layers, and a method of producing the same.

2. Description of Related Arts

Generally, an EL element is produced by laminating a first electrode, a first insulating layer, a luminous layer, a second insulating layer, and a second electrode in this order. The luminous layer emits light when a voltage is applied between the first and second electrodes.

U.S. Pat. No. 4,486,487 (corresponding to JP-A-58-206095) discloses an Al₂O₃/TiO₂ laminated structure film (hereinafter referred to as ATO film), which is used as the insulating layer. The ATO film has a higher withstand voltage compared with an Al₂O₃ film. The ATO film is formed by layering the Al₂O₃ film as an insulator and a TiO₂ film as a conductor alternately.

Especially, when the ATO film is formed by an atomic layer epitaxy method (hereinafter referred to as ALE method), the ATO film can be formed relatively thin. Moreover, because coating performance of the ATO film is better, the ATO film can provide a defect-free membrane. Therefore, the ATO film can be used for the insulating layer of the EL element.

Furthermore, an ATO film is conventionally disclosed in JP-A-2004-234889, in which a ratio of the TiO₂ film to the ATO film is increased so that the withstand voltage is enhanced.

However, when the ratio of the TiO₂ film to the ATO film is increased, the ATO film becomes stressed so that a crack may be generated.

### SUMMARY OF THE INVENTION

In view of the foregoing and other problems, it is an object of the present invention to provide an EL element, in which an insulation performance is secured and a generation of a crack is prevented.

According to an example of the present invention, an EL element includes an insulating substrate, a first electrode on the insulating substrate, a first insulating layer on the first electrode, a luminous layer on the first insulating layer, a second insulating layer on the luminous layer and a second electrode on the second insulating layer. At least one of the first insulating layer and the second insulating layer is an HfO₂/TiO₂ film, in which a plurality of HfO₂ films and a plurality of TiO₂ films are layered alternately.

According to an another example of the present invention, a method of producing an EL element includes an layering process, in which a HfO₂ film and a TiO₂ film are layered alternately so as to form a HfO₂/TiO₂ film at a temperature of 400° C. or more, and a laminating process, in which a first electrode, a first insulating layer, a luminous layer, a second insulating layer, and a second electrode are laminated in this order on an insulating substrate. At least one of the first insulating layer and the second insulating layer is the HfO₂/TiO₂ film.

According to the above-described examples, the EL element can be produced, in which the insulation performance is secured and the generation of the crack is prevented.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic cross-sectional view of an EL element according to an embodiment of the present invention;

FIG. 2 is a graph showing a relationship between a ratio of a TiO₂ film to a HTO film and a breakdown electric charge according to the embodiment of the present invention;

FIG. 3 is a graph showing a relationship between a chlorine concentration in the HTO film and a luminance of the EL element according to the embodiment of the present invention; and

FIG. 4 is a graph showing a relationship between a temperature for forming the HTO film and XRD intensity in the TiO₂ film according to the embodiment of the present invention.

### DETAILED DESCRIPTION OF PREFERRED EMBODIMENT

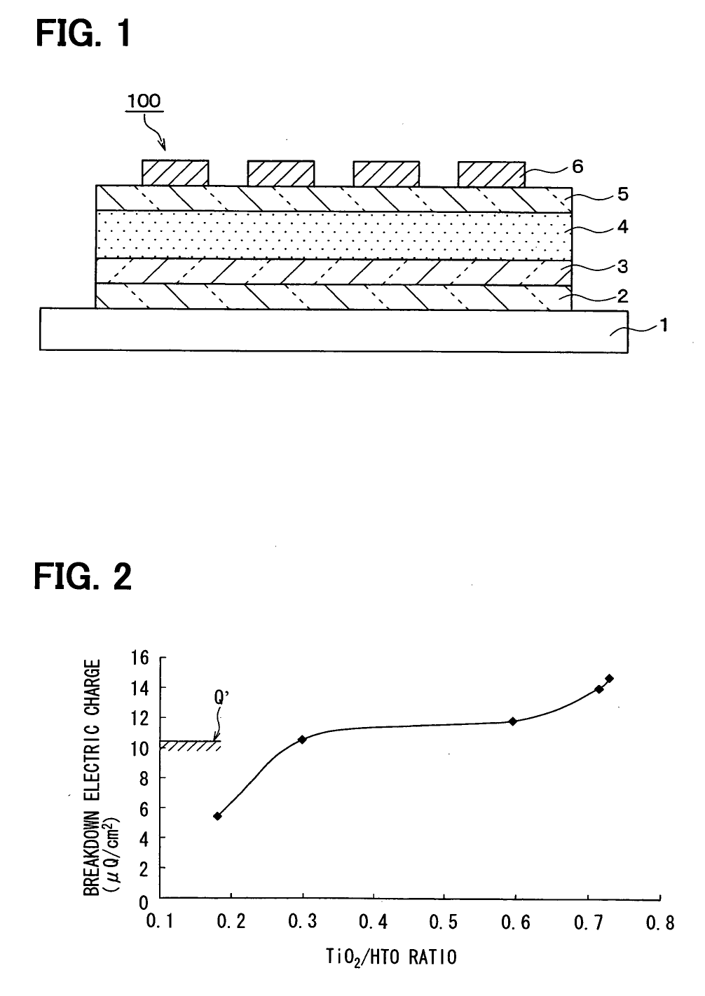

A schematic cross-sectional view of an EL element 100 according to an embodiment of the present invention is shown in FIG. 1.

The EL element 100 is formed by stacking a first electrode 2, a first insulating layer 3, a luminous layer 4, a second insulating layer 5, and a second electrode 6 on a glass substrate 1 in this order. The glass substrate 1 is an insulating substrate. At least a light-emitted side of the first electrode 2, the first insulating layer 3, the second insulating layer 5 and the second electrode 6 is made of a material having a translucency.

The electrodes 2, 6 are stripes made of transparent ITO (Indium Tin Oxide) films, and extend to be perpendicular to each other. Orthogonal positions of the electrodes 2, 6, provide pixels with the first insulating layer 3, the second insulating layer 5, and the luminous layer 4, which are sandwiched by the orthogonal positions of the electrodes 2, 6.

When a voltage is applied between the electrodes 2, 6, the luminous layer 4 emits light in the pixels. The emitted light is transmitted through the first insulating layer 3, the first electrode 2 and the glass substrate 1 so as to be emitted from the other side of the glass substrate 1.

The luminous layer 4 is made of a semiconductor material, e.g., ZnS, ZnSe, and Mn, Tb, and Sm can be used as a center of the luminescence. When Mn is used, a yellow-orange luminescence is emitted. When Tb is used, a green luminescence is emitted. When Sm is used, a red luminescence is emitted. In the embodiment, the luminous layer 4 is a ZnS:Mn film.

The insulating layers 3, 5 are made of a transparent insulating film including a dielectric such as TiO₂, Al₂O₃, SiO₂, and Si₃N₄. For example, the insulating layers 3, 5 are made of a HTO film, an ATO film, or a ZTO film. The HTO film is formed by layering an HfO₂ film and a TiO₂ film alternately. The ATO film is formed by layering an Al₂O₃ film and a TiO₂ film alternately. The ZTO film is formed by layering a ZrO₂ film and a TiO₂ film alternately. At least one of the insulating films 3, 5 is made of the HTO film.

In the embodiment, the first insulating layer 3 is made of the ATO film, and the second insulating layer 5 is made of the HTO film. To be specific, the ATO film includes six layers of the Al₂O₃ films and five layers of the TiO₂ films. A thickness of one layer of the Al₂O₃ film is 5 nm, and a thickness of one layer of the TiO₂ film is 30 nm.

In addition, a ratio of the total thickness of the TiO₂ film to that of the HTO film is equal to or more than 0.3. The ratio of the total thickness of the TiO₂ film to that of the HTO film is called a TiO₂/HTO ratio. The ratio of the total thickness of the TiO₂ film to that of the ATO film is called a TiO₂/ATO ratio. When the TiO₂/HTO ratio is set equal to or more than 0.3, advantages described later can be obtained.

In the embodiment, the HTO film is made by the ALE method. A thickness of one layer of the HfO₂ film is 17 nm, and a thickness of one layer of the TiO₂ film is 30 nm, for example. The HTO film includes six layers of the HfO₂ films and five layers of the TiO₂ films. The top and bottom layers are HfO₂ films. However, the top and bottom layers of the HTO film may be either the HfO₂ film or the TiO₂ film. The HfO₂ film and the TiO₂ film are layered alternately.

In this case, the total thickness of the HfO₂ films is 102 nm, the total thickness of the TiO₂ films is 150 nm, and the total thickness of the HTO film is 252 nm so that the TiO₂/HTO ratio is 0.60.

Further, when the HTO film is formed in the atomic layer order by the ALE method, the thickness of one layer of the HfO₂ film can be a value between 0.5 nm and 100 nm. If the thickness is smaller than 0.5 nm, the HfO₂ film cannot function as the insulator. If the thickness is larger than 100 nm, an effect of improving a withstand voltage by the laminated structure is lowered.

Next, a method of producing an EL element will be described in accordance with the above-described example. Firstly, a pattern of an optically transparent ITO film as the first electrode 2 is formed on the glass substrate 1 by a sputter method or a photolithography.

The ATO film is formed on the first electrode 2 as the first insulating layer 3 by the ALE method. The ATO film is formed using a generally known method.

Next, the luminous layer 4 made of the ZnS:Mn is formed on the first insulating layer 3 by an evaporation method. The thickness of the luminous layer 4 is between 100 nm and 2000 nm. If the thickness is smaller than 100 nm, areas not contributing to the luminescence are increased so that the luminescence efficiency is decreased. If the thickness is larger than 2000 nm, a drive voltage is increased.

Then, the HTO film is formed as the second insulating layer 5 by the ALE method. The HfO₂ film is made from HfCl₄ and H₂O, and the TiO₂ film is made from TiCl₄ and H₂O by the ALE method. A temperature of the substrate is equal to or more than 400° C.

In a first step, the HfO₂ film is formed using HfCl₄ gas and H₂O gas as materials. The gases are supplied alternately so as to form one-by-one atomic layers by the ALE method. Therefore, after the HfCl₄ gas is introduced to a reactor for one second by a carrier gas of N₂, a sufficient purge for exhausting the HfCl₄ gas from the reactor is performed.

Next, after the H₂O gas is introduced to the reactor for one second by the carrier gas of N₂, a sufficient purge for exhausting the H₂O gas from the reactor is performed. By repeating this cycle, the HfO₂ film having a predetermined thickness can be formed.

In a second step, the TiO₂ film is formed using TiCl₄ gas and H₂O gas as materials. To be specific, after the TiCl₄ gas is introduced to a reactor for one second by the carrier gas of N₂, a sufficient purge for exhausting the TiCl₄ gas from the reactor is performed.

Next, after the H₂O gas is introduced to the reactor for one second by the carrier gas of N₂, the sufficient purge for exhausting the H₂O gas from the reactor is performed. By repeating this cycle, the TiO₂ film having a predetermined thickness can be formed.

The HfO₂ film and the TiO₂ film are layered alternately by repeating the first step and the second step so that the HTO film having a predetermined thickness is formed.

The method for forming the ATO film as the first insulating layer 3 is similar to the method for forming the HTO film described above. In the first step, by using AlCl₃ and H₂O, the Al₂O₃ film can be formed in place of the HfO₂ film.

Then, a pattern of the ITO film as the second electrode 6 is formed on the second insulating film 5 by the sputter method or the photolithography. Accordingly, the EL element 100 shown in FIG. 1 can be produced.

The reason why the TiO₂/HTO ratio is equal to or more than 0.3 as described above will be described below in accordance with a result of experiments.

In the experiments, the HTO films having a variety of the TiO₂/HTO ratio are made so as to make it clear that how much the ratio should be in order to secure the insulation adequately.

FIG. 2 is a graph showing a relationship between the TiO₂/HTO ratio and a breakdown electric charge (unit: μQ/cm²). The breakdown electric charge is a general index showing the insulation characteristic of the insulating layer, and corresponds to a product of the insulating layer capacity multiplied by the withstand voltage of the insulating layer. That is, when the breakdown electric charge is larger, the insulation of the insulating layer is larger.

As a comparative example, an EL element is formed, in which the conventional ATO film having the largest insulation characteristic is used as the second insulating layer 5. The ratio of TiO₂/ATO is 0.88 in the layer 5 of the comparative example. In the ATO film, the ratio of TiO₂ is enhanced so that the insulation is enhanced as long as a crack is not generated.

In the ATO film as the comparative example, the other structures, e.g., capacity, may be set similarly to the above-described HTO film (TiO₂/HTO ratio is 0.60) except for replacing the HfO₂ film with the Al₂O₃ film.

A breakdown electric charge Q′ of the comparative example is shown in FIG. 2, as a breakdown electric charge which is generally the highest level in prior art. As shown in FIG. 2, when the ratio TiO₂/HTO is equal to or more than 0.3, the breakdown electric charge of the HTO film is larger than that of the comparative example so that the same or more insulation capacity is secured in the HTO film compared with that of the conventional ATO film.

In addition, a generation of a crack is not caused in this range of the TiO₂/HTO ratio. Moreover, when the ratio of TiO₂/HTO is close to 1.0, the characteristic of the HTO film will change, because the insulating function is performed by the layering of the HfO₂ film and the TiO₂ film alternately.

However, as shown in FIG. 2, when the ratio of TiO₂/HTO is increased in the range in which the ratio of TiO₂/HTO is equal to or more than 0.3, the breakdown electric charge is increased so that the insulation is improved. That is, in the range in which the HTO film functions as the insulating film in the EL element 100, the same or more insulation is secured compared with that of the conventional ATO film.

Accordingly, when the ratio of TiO₂/HTO is equal to or more than 0.3, the adequate insulation is secured without using the ATO film.

In this experiment, the withstand voltage of the HTO film is 83V, when the ratio of TiO₂/HTO is 0.60. In contrast, the withstand voltage of the ATO film having the same capacity as the HTO film is 63V. By replacing the ATO film with the HTO film, the withstand voltage can be improved by about 20V, while the ratio of the TiO₂ film is decreased.

That is, by replacing the ATO film with the HTO film as the insulating layer 5 in the EL element 100, the ratio of the thickness of the TiO₂ film to that of the HTO film can be decreased, while the insulation is secured. Accordingly, the stress of the HTO film can be decreased, so that the generation of the crack can be prevented.

When the ATO film is formed as the insulating layer of the EL element, the total thickness of the Al₂O₃ film is usually up to 200 nm. The dielectric constant of the HfO₂ film is 2-3 times larger than that of the Al₂O₃ film so that the total thickness of the HfO₂ film is equal to or less than 600 nm in order to have the same capacity as the Al₂O₃ film.

Moreover, a luminance-voltage characteristic of the EL element 100 using the HTO film is almost the same as that of the EL element using the ATO film having the same capacity. The voltage of the EL element 100 using the HTO film in order to obtain a luminance of 1 cd/m² is also the same as that of the EL element using the ATO film as the comparative example. The voltage for obtaining a luminance of 1 cd/m² is defined as luminescence threshold voltage in a display element field. Accordingly, the withstand voltage in the EL element 100 in the embodiment is larger than that of the conventional ATO film so that the drive voltage can be raised and the luminance can be improved.

In addition, when the ATO film and the HTO film having the same withstand voltage Vb are compared, an effect of the HTO film can be expected as below.

Generally, when a voltage is applied to an EL element, partial pressures in inverse ratio to capacities are applied to a luminous layer and an insulating layer. For example, the ratio of V1 to V2 is equal to the ratio of C2 to C1, when the capacity of the luminous layer is C1, the capacity of the insulating layer is C2, the voltage applied to the luminous layer is V1, and the voltage applied to the insulating layer is V2. Moreover, when the withstand voltage of the insulating layer is Vb, the product of C2 multiplied by Vb, i.e., breakdown electric charge, of the HTO film is larger than that of the ATO film as shown in FIG. 2.

When the ATO film and the HTO film having the same withstand voltage Vb are compared, the capacity C2 of the HTO film is larger than that of the ATO film. Thus, the voltage V2 of the HTO film can be smaller than that of the ATO film. In order to obtain the same luminance, the drive voltage of the EL element 100 using the HTO film can be smaller than that of the EL element using the conventional ATO film.

Furthermore, when the ATO film and the HTO film having the same withstand voltage Vb are compared, the capacity C2 of the HTO film can be larger than that of the ATO film. Thus, a change of an inner electric field in the element increases corresponding to a change of the applied voltage from an outside so that the luminescence threshold voltage decreases and the rising edge of the luminance-voltage characteristic becomes steep.

Accordingly, when the applied voltages corresponding to the luminescence threshold voltages, i.e., drive voltages, are the same between the ATO film and the HTO film, the luminance of the HTO film can be improved compared with that of the ATO film. The drive voltage of the HTO film in order to obtain the same luminance can be lowered compared with that of the ATO film. That is, the EL element 100 capable to be driven by a lower voltage can be produced by using the HTO film.

Furthermore, because the drive voltage of the EL element 100 is low, a heat generation can be reduced and a reliability is expected to be improved. Also, a drive circuit can be constructed with parts having a lower withstand voltage so that the drive circuit can be produced at a low cost. Moreover, an electric power consumption for the EL element 100 and the drive circuit can be reduced.

In addition, in the embodiment of the present invention, a chlorine concentration included in the HTO film is set equal to or less than 2*10¹³ atom/cm² based on experiments.

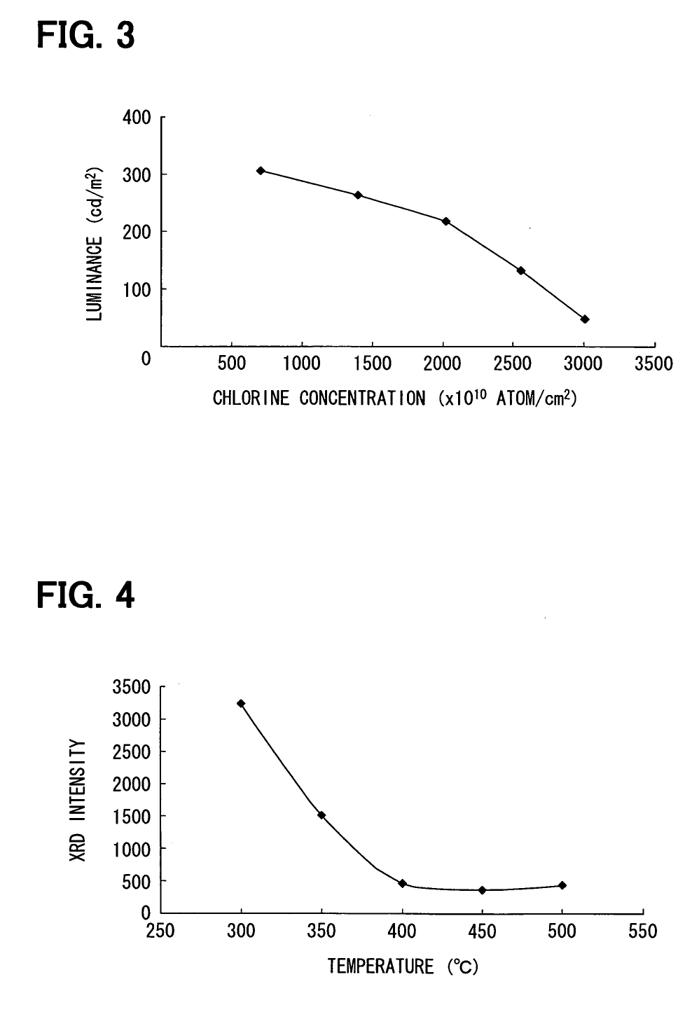

In the experiments, a relationship between the chlorine concentration and a luminance of the EL element 100 is examined. The result of the experiment is shown in FIG. 3. FIG. 3 is a graph showing a relationship between the chlorine concentration (unit: 10¹⁰ atom/cm²) and the luminance (cd/m²). Total reflection X-ray Fluorescence performs the measurement of the chlorine concentration.

As shown in FIG. 3, a lowering rate of the luminance in a range in which the chlorine concentration is equal to or less than 2*10¹³ atom/cm² is relatively gradual. However, the lowering rate of the luminance in a range in which the chlorine concentration is more than 2*10¹³ atom/cm² becomes steep.

That is, when the chlorine concentration is more than 2*10¹³ atom/cm², the lowering rate of the luminance becomes high. The reason for this is Cl atoms diffuse from the second insulating film 5 into the luminous layer 4 so that the efficiency of the luminescence is reduced by the excess Cl atoms. Accordingly, the chlorine concentration is set equal to or less than 2*10¹³ atom/cm² in order to secure the adequate luminance.

Moreover, in the method of producing the EL element 100 in the embodiment, the HTO film is formed at the temperature equal to or more than 400° C.

When the HTO film is formed by the ALE method in a variety of temperatures, i.e., temperatures of the substrate, a crystal structure of the TiO₂ film in the HTO film is analyzed by an X-ray diffraction. The result of the analysis is shown in FIG. 4.

FIG. 4 is a graph showing a relationship between the temperature for forming the HTO film (unit: ° C.) and the anatase-type X-ray diffraction intensity (XRD intensity) of the TiO₂ film in the HTO film. When the temperature is more than 400° C., the anatase-type XRD intensity is lowered.

This is because the crystal structure in the TiO₂ film changes from the anatase-type to a rutile-type when the temperature is more than 400° C. A dielectric constant of the rutile-type is larger than that of the anatase-type. Thus, even if the total thickness of the TiO₂ film, i.e., conductor in the HTO film, is increased, a contribution to a capacity component by the TiO₂ film can be decreased.

Further, the HTO film is formed by layering the HfO₂ film and the TiO₂ film alternately. The HfO₂ film and TiO₂ film are formed using chlorides and water.

An organic metal can be used for forming the HfO₂ film and the TiO₂ film. However, impurities such as organic matters are easily taken into the HTO film. In contrast, the impurities are difficult to be taken into the HTO film in the method of producing the EL element 100 in the embodiment.

The HTO film may be formed not only by the ALE method but also by a sputter method or CVD.

The first insulating film 3 may be the HTO film and the second insulating film 5 may be the ATO film in the EL element 100. Alternatively, both the first and second insulating films may be the HTO films.

The structure of the electrodes 2,6 and the luminous layer 4 are not limited to the above description, and the structure thereof may be changed.

Such changes and modifications are to be understood as being within the scope of the present invention as defined by the appended claims.

What is claimed is:

1. An EL element comprising:
an insulating substrate;
a first electrode on the insulating substrate;
a first insulating layer on the first electrode;
a luminous layer on the first insulating layer;
a second insulating layer on the luminous layer; and
a second electrode on the second insulating layer, wherein at least one of the first insulating layer and the second insulating layer is an HfO₂/TiO₂ film in which a plurality of HfO₂ films and a plurality of TiO₂ films are layered alternately.

2. The EL element according to claim 1, wherein:
a ratio of a total thickness of the TiO₂ film to a total thickness of the HfO₂/TiO₂ film is equal to or more than 0.3.

3. The EL element according to claim 1, wherein:
a chlorine concentration included in the HfO₂/TiO₂ film is equal to or less than 2*10¹³ atom/cm².

4. The EL element according to claim 1, wherein:
the HfO₂/TiO₂ film is formed at a temperature of 400° C. or more.

5. The EL element according to claim 1, wherein:
the HfO₂/TiO₂ film is formed by an atomic layer epitaxy method such that the HfO₂ film is formed from HfCl₄ and H₂O, and that the TiO₂ film is formed from TiCl₄ and H₂O.

6. A method of producing an EL element comprising:
alternately layering a HfO₂ film and a TiO₂ film so as to form a HfO₂/TiO₂ film at a temperature of 400° C. or more; and
laminating a first electrode, a first insulating layer, a luminous layer, a second insulating layer, and a second electrode in this order on an insulating substrate, wherein at least one of the first insulating layer and the second insulating layer is the HfO₂/TiO₂ film.

7. The method according to claim 6, wherein:
the HfO₂/TiO₂ film is formed by an atomic layer epitaxy method such that the HfO₂ film is formed from HfCl₄ and H₂O, and that the TiO₂ film is formed from TiCl₄ and H₂O.

8. The method according to claim 6, wherein:
a ratio of a total thickness of the TiO₂ film to a total thickness of the HfO₂/TiO₂ film is equal to or more than 0.3.

9. The method according to claim 6, wherein:
a chlorine concentration included in the HfO₂/TiO₂ film is equal to or less than 2*10¹³ atom/cm².
